(19) United States
(12) Patent Application Publication
(10) Pub. No.: US 2026/0156334 A1
(43) Pub. Date: Jun. 4, 2026

(54) OPTICAL DEVICE

(71) Applicant: Japan Display Inc., Tokyo (JP)

(72) Inventors: Hitoshi TANAKA, Tokyo (JP); Yoshiro AOKI, Tokyo (JP); Hirondo NAKATOGAWA, Tokyo (JP)

(73) Assignee: Japan Display Inc., Tokyo (JP)

(21) Appl. No.: 19/408,424

(22) Filed: Dec. 4, 2025

(30) Foreign Application Priority Data
Dec. 4, 2024 (JP) 2024-211585

(51) Int. Cl. H04N 23/16; G02F 1/1335; G06T 7/571; H04N 23/11; H04N 23/95

(52) U.S. Cl. CPC H04N 23/16; G02F 1/133528; G06T 7/571; H04N 23/11; H04N 23/95; G06T 2207/10024

(57) ABSTRACT

According to an embodiment, an optical device includes a liquid crystal panel which displays a coded aperture pattern, an optical system including a lens, an imaging device including a plurality of sensor elements and a plurality of color filters, and a controller connected to the liquid crystal panel, the optical system, and the imaging element, wherein the liquid crystal panel comprises a polarizer which modulates infrared light and transmits visible light.

### CROSS-REFERENCE TO RELATED APPLICATIONS

This application is based upon and claims the benefit of priority from Japanese Patent Application No. 2024-211585, filed Dec. 4, 2024, the entire contents of which are incorporated herein by reference.

### FIELD

Embodiments described herein relate generally to an optical device.

### BACKGROUND

Devices which can transmit infrared light have been developed. In particular, imaging systems which can transmit both infrared light and visible light to an image sensor have been developed.

### BRIEF DESCRIPTION OF THE DRAWINGS

FIG. 1 is an exploded perspective view showing a configuration example of an optical device according to an embodiment.

FIG. 2 is a schematic diagram illustrating the principle of calculating the distance to an object using an image picked up.

FIG. 3 is a perspective view illustrating FIG. 2 in more detail.

FIG. 4 is a plan view showing an example of a coded aperture pattern.

FIG. 5 is a plan view showing another example of the coded aperture pattern.

FIG. 6 is a diagram schematically showing a configuration example of the optical device of the embodiment.

FIG. 7 is a diagram showing the driving of the optical device.

FIG. 8 is a diagram showing an example of an equivalent circuit of a liquid crystal panel.

FIG. 9 is a cross-sectional view showing an example of a configuration the liquid crystal panel.

### DETAILED DESCRIPTION

In general, according to one embodiment, an optical device comprises
a liquid crystal panel which displays a coded aperture pattern;
an optical system including a lens;
an imaging device including a plurality of sensor elements and a plurality of color filters; and
a controller connected to the liquid crystal panel, the optical system, and the imaging device,
wherein
the liquid crystal panel comprises a polarizer which modulates infrared light and transmits visible light.

An object of this embodiment is to provide an optical device capable of suppressing a reduction in the amount of light reaching the imaging surface of the imaging device. Another objective of this embodiment is to provide an optical device capable of reducing the processing time of the controller.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of an optical device with reference to the drawings.

In this embodiment, a first direction X, a second direction Y and a third direction Z are orthogonal to each other, but may intersect at an angle other than 90 degrees. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the illumination device on a tip side of the arrow in the third direction Z. Here, viewing from this observation position toward the X-Y plane defined by the first direction X and the second direction Y is referred to as plan view. Viewing a cross-section of the optical device in the X-Z plane defined by the first direction X and the third direction Z or in the Y-Z plane defined by the second direction Y and the third direction Z is referred to as cross-sectional view.

### Embodiments

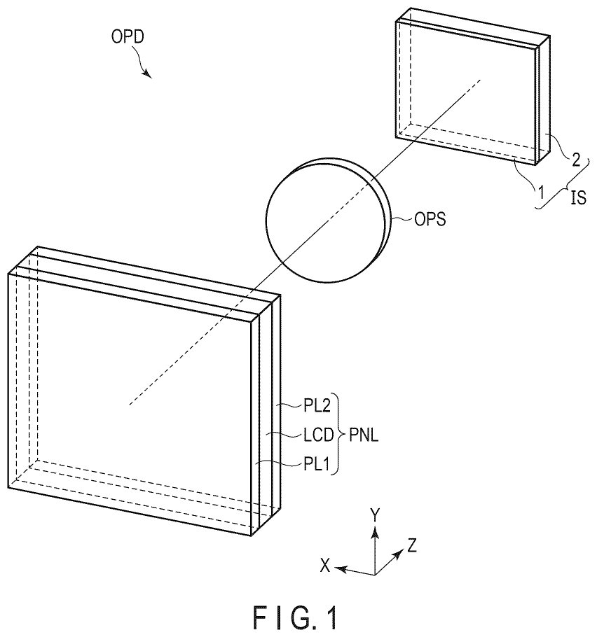

FIG. 1 is an exploded perspective view showing a configuration example of an optical device OPD according to an embodiment. The optical device OPD shown in FIG. 1 comprises a liquid crystal panel PNL, an imaging element (image sensor) IS, and an optical system OPS. The imaging element IS is disposed on a rear surface side of the liquid crystal panel PNL. The optical system OPS is disposed between the liquid crystal panel PNL and the imaging element IS.

That is, in the optical device OPD, the liquid crystal panel PNL, the optical system OPS, and the imaging element IS are arranged in this order along the third direction Z. The optical system OPS includes at least one lens. The optical device OPD can also be considered an imaging device that captures imaged of objects via the liquid crystal panel PNL, the optical system OPS, and the imaging element IS.

Note that FIG. 1 is a diagram illustrating the positions of the liquid crystal panel PNL, the optical system OPS, and the imaging element IS relative to each other along the third direction Z. In FIG. 1, the size and shape of each of the liquid crystal panel PNL, optical system OPS, and imaging element IS are shown in simplified form.

The liquid crystal panel PNL comprises a polarizer PL1, a liquid crystal element LCD, and a polarizer PL2. The liquid crystal device LCD comprises an array substrate, a counter substrate, and a liquid crystal layer. The liquid crystal layer is disposed between the array substrate and the counter substrate.

The liquid crystal panel PNL according to the embodiment exhibits a transparent state (transmissive state) when no electric field is applied to the liquid crystal layer, whereas it exhibits an absorptive state (colored state, light-shielding state, or light-attenuating state) when an electric field is applied to the liquid crystal layer. The liquid crystal panel PNL can be driven using a simple matrix method or an active matrix method.

In the optical device OPD of the embodiment, when the liquid crystal panel PNL is in the transparent state, light transmitted through the liquid crystal panel PNL and the optical system OPS is incident on the imaging element IS. Thus, the optical device OPD can capture an image based on the light incident on the imaging element IS.

When the liquid crystal panel PNL is in an absorption state, a coded aperture pattern is displayed on the liquid crystal panel PNL. As will be described in detail later, the coded aperture pattern includes multiple incident light control areas. On the imaging element IS, light transmitted through the liquid crystal panel PNL displaying the coded aperture pattern and the optical system OPS is incident. With this configuration, the optical device OPD can calculate the distance to the object using coded aperture technology, from the image based on the light incident on the imaging element IS.

### Coded Aperture Technology

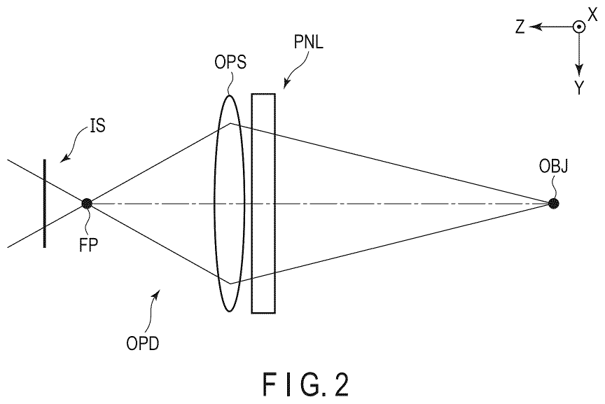

FIG. 2 is a schematic diagram illustrating the principle of calculating the distance to the object using the captured image. As described above, the optical device OPD includes a liquid crystal panel PNL, an imaging element IS, and an optical system OPS. The optical system OPS is disposed between the liquid crystal panel PNL and the imaging element IS. The optical system OPS has at least one lens. Note here that the configuration of the optical system OPS is not limited to this and may include other necessary components besides lenses.

The case of calculating the distance to the object OBJ will now be described. Generally, when the imaging element IS captures an object OBJ, the distance between the optical system OPS and the imaging element IS is varied to find the focal point, and the object is captured in focus. On the other hand, as shown in FIG. 2, when the object OBJ is captured out of focus, a misalignment occurs between the focal point FP and the position of the imaging surface of the imaging element IS. Consequently, the image based on light entering the imaging element IS exhibits blurring.

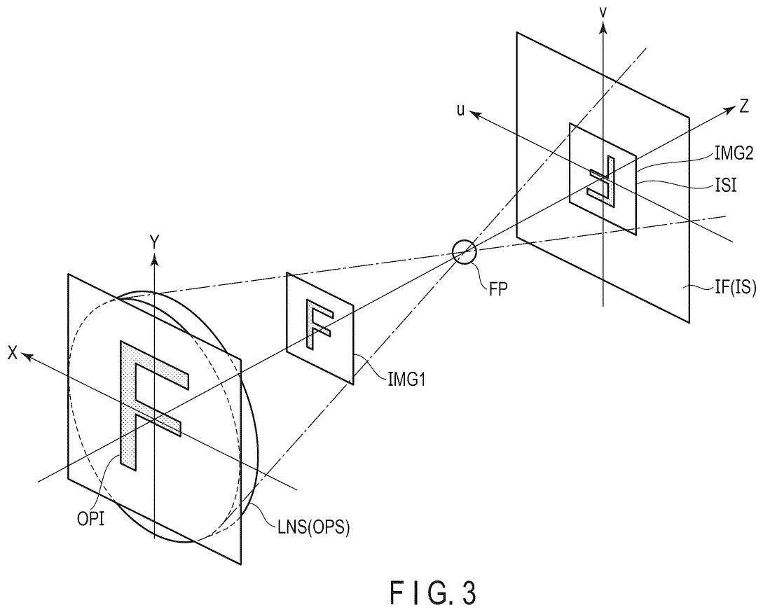

FIG. 3 is a perspective view illustrating what is shown in FIG. 2 in more detail. FIG. 3 shows a lens LNS included in the optical system OPS, an image OPI when passing through the lens LNS (optical system OPS), the focal point FP, an image IMG1 located between the focal point FP and the lens LNS, an image IMG2 located at a position farther than the focal point FP, and an imaging plane IF of the imaging element IS. The imaging plane IF is a plane constituted by a fourth direction u, parallel to the first direction X, and a fifth direction v, parallel to the second direction Y. The image ISI is the image captured on the imaging plane IF.

The image OPI passing through the lens LNS (optical system OPS) is, as shown in FIG. 2, the image that has passed through the liquid crystal panel PNL. On the liquid crystal panel PNL, an image of the coded aperture pattern in the X-Y plane is displayed. With this configuration, it can be the that the image OPI contains encoded aperture data.

The image IMG1 and the image IMG2 are blurred images containing information similar to the encoded aperture. The image IMG1 is located between the focal point FP and the lens LNS, and therefore it has the same shape as that of the image OPI but a different size. The image IMG2 is located farther than the focal point FP, and therefore it has a point-symmetric shape relative to the shape of the image OPI and a different size.

The distance from the focal point FP can be measured based on the degree of blur in the image IMG1 and the image IMG2. However, when the distance between the image IMG1 and the focal point FP is the same as the distance between the image IMG2 and the focal point FP, they have the same degree of blur. If the shape of the image OPI when passing through the lens LNS (optical system OPS) is point-symmetric, the shapes of the image IMG1 and the image IMG2 becomes identical. This is because the shapes of the image IMG1 and the image IMG2 are the same as the shape of the image OPI.

Therefore, as shown in FIG. 3, for the image OPI, a non-point-symmetric shape is used. With this configuration, information as to whether the image ISI captured on the imaging plane IF is closer to or farther from the focal point FP, as well as information as to the distance between the image ISI and the focal point FP can be obtained.

As shown in FIG. 3, when the image ISI captured on the imaging plane IF is the image IMG2, the shape of the image ISI is point-symmetric with respect to the image OPI. With this configuration, it can be known that the image ISI is farther than the focal point FP. Although not shown in FIG. 3, when the image ISI is the image IMG1, the position of the image ISI becomes the same as that of the image OPI. With this configuration, it can be understood that the image ISI is closer to the lens LNS than to the focal point FP.

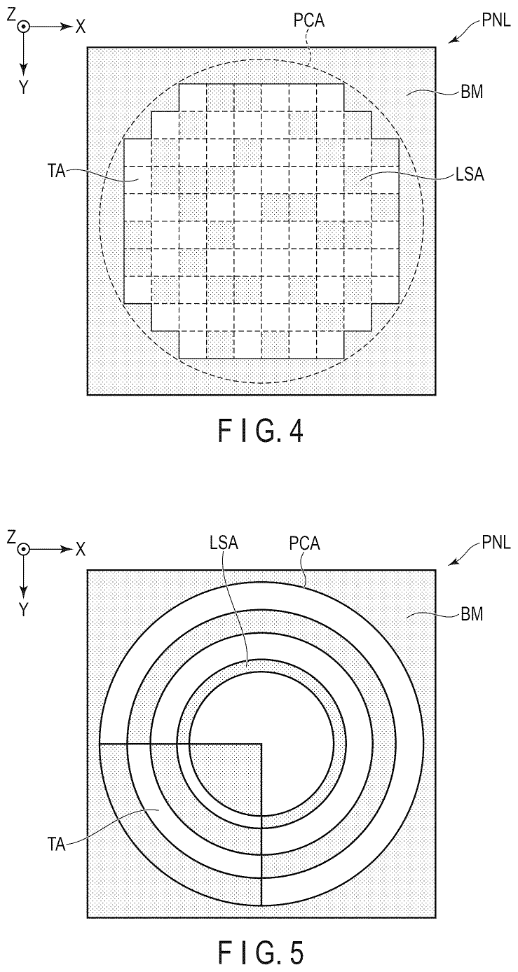

The coded aperture pattern displayed on the liquid crystal panel PNL will now be described. For the coded aperture pattern, an image that is not point-symmetric is used. FIGS. 4 and 5 are plan views each showing an example of the coded aperture pattern.

Although not shown, the liquid crystal panel PNL has a display area that display images and a non-display area on an outer side of the display area. In the display area, an incident light control area PCA is provided. In the area of the display area other than the incident light control area PCA, a light-shielding area BMA is provided.

The incident light control area PCA shown in FIGS. 4 and 5 has a circular shape corresponding to the lens LNS. The incident light control area PCA has a plurality of light-transmitting areas TA and a plurality of light-shielding areas LSA. In FIGS. 4 and 5, the dotted areas represent the light-shielding areas LSA, respectively. The light-transmitting areas TA and light-shielding areas LSA are formed by controlling the voltage applied to the liquid crystal layer of the liquid crystal panel PNL.

FIG. 4 shows an example in which the light-transmitting areas TA and light-shielding areas LSA are arranged in a matrix pattern. In FIG. 4, each of the light-transmitting areas TA and each of the light-shielding areas LSA have, for example, a square shape. These square-shaped light-transmitting areas TA or light-shielding areas LSA, which have the square shape, are combined with each other to form a non-point-symmetric image (coded aperture pattern).

In the example shown in FIG. 5, the shape of each of the light-transmitting areas TA and the shape of each of the light-shielding areas LSA are a portion of a ring shape. The light-transmitting areas TA or light-shielding areas LSA having this ring-shaped portion configuration are combined to form a non-point-symmetric image (coded aperture pattern).

When imaging the object OBJ, light from the object OBJ is allowed to pass through the coded aperture pattern displayed on the liquid crystal panel PNL (see FIGS. 2 and 3). The light having passed through the coded aperture pattern then passes through the lens LNS (optical system OPS). The light passing through the lens LNS forms the image OPI as it transmits through the lens LNS (optical system OPS) described above.

The image ISI formed on the imaging plane IF has a shape similar to the image OPI or a shape point-symmetrical to the similar shape. As described above, when the object OBJ is captured out of focus, a misalignment occurs between the focal point FP and the position of the imaging plane IF of the imaging element IS. Consequently, blurring occurs in the image ISI.

The state of such blur depends on the point spread function determined by factors such as the shape of the coded aperture pattern and the like. Based on the point spread function specific to the coded aperture pattern, decoding is performed on the blurred image ISI. In this manner, a decoded image with improved blur and depth information (distance) corresponding to the position in the decoded image are obtained.

As described above, according to the encoded aperture technology, the distance to the object OBJ is calculated based on the blurring occurring in the image ISI captured on the imaging plane IF.

Here, the issues with optical devices OPD using liquid crystal panels PNL will be described. As shown in FIG. 1, a liquid crystal panel PNL is provided with a polarizer PL1 and a polarizer PL2. Note here that the polarizer PL1 and polarizer PL2 absorbs a certain proportion of the transmitted light when the light passes therethrough.

When light is absorbed by the polarizer PL1 and the polarizer PL2, the amount of light reaching the imaging surface IF of the imaging element IS decreases. As a result, the S/N ratio at the imaging surface IF decreases, potentially deteriorating the accuracy of the encoded information.

There rises a necessity to compensate for the reduced light. For example, this can be achieved by prolonging the exposure time at the imaging element IS or by increasing the rate of gain when converting the detected light into current.

Incidentally, the imaging device IS is provided with a sensor element (for example, a CMOS sensor) 1 and color filters 2. Light from the object OBJ passes through the color filters of the imaging device IS and is detected as respective information of red (R), green (G), and blue (B). Here, as to the light from the object OBJ passing through the encoding aperture pattern of the liquid crystal panel PNL, there is a risk that appropriate encoding aperture data is lost from the light where the gradations of red (R), green (G), and blue (B) are saturated. In other words, when the gradations of red (R), green (G), and blue (B) are saturated in the image passing through the liquid crystal panel PNL, even if it passes through the encoding aperture pattern of the liquid crystal panel PNL, the degree of blurring becomes similar, and there is a risk that depth information cannot be obtained.

Further, the information of red (R), green (G), and blue (B) detected by the imaging element IS are converted to grayscale. Using this grayscale information, the controller of the optical device OPD calculates the distance to the object OBJ. As described so far, when an object is detected using an imaging element equipped with color filters, there is a risk of requiring additional processing time to convert the red (R), green (G), and blue (B) information into grayscale information.

In the embodiment, for the polarizer PL1 and the polarizer PL2 of the liquid crystal panel PNL, polarizers that polarize infrared light only and transmit visible light are used. With this configuration, it is possible to suppresses the reduction in the amount of light reaching the imaging surface IF of the imaging element IS. Further, even when the gradations of red (R), green (G), and blue (B) are saturated, it is still possible to measure the distance to the object OBJ more accurately. Further, since there is no need to convert red (R), green (G), and blue (B) to grayscale, the processing time of the controller of the optical device OPD can be shortened.

### Configuration of Optical Device

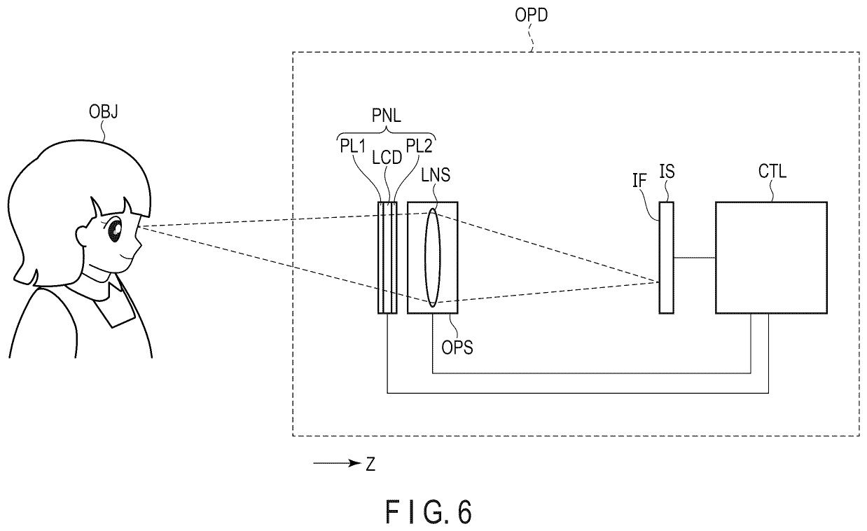

FIG. 6 is a diagram schematically showing a configuration example of the optical device of the embodiment. The optical device OPD shown in FIG. 6 includes a liquid crystal panel PNL, an optical system OPS, an imaging element IS, and a controller CTL. Note that the third direction Z in FIG. 6 coincides with the principal axis direction of the optical system OPS.

The liquid crystal panel PNL, as described above, comprises a polarizer PL1, a liquid crystal device LCD, and a polarizer PL2. The polarizer PL1 and polarizer PL2 polarize only infrared (IR) light and transmit visible light.

The imaging element IS includes, for example, a plurality of sensor elements arranged in a matrix and a plurality of color filters corresponding to these sensor elements, respectively. The sensor elements may be, for example, the CMOS sensors described above. Note here that sensor elements are not limited to these and may be other photoelectric conversion elements, such as CCD sensors. These sensor elements include a plurality of first sensor elements that detect visible light and a plurality of second sensor elements that detect infrared light.

Light incident on the imaging plane IF of the imaging element IS passes through the color filters. Information of each of red (R), green (G), and blue (B) components of the light (visible light) transmitted through the color filter is detected by the sensor elements.

In the optical device OPD of the embodiment, the light from the object OBJ contains both visible light and infrared light. The infrared light is modulated by the liquid crystal panel PNL. This modulated infrared light is detected by the infrared-detecting sensor elements (second sensor elements) of the imaging element IS. Here, with use of the encoding aperture technology described above, depth information of the object OBJ can be obtained.

The visible light is not modulated by the liquid crystal panel PNL and is transmitted therethrough. This transmitted visible light is detected by the first sensor elements of the imaging device IS, which detect visible light. With this configuration, the color information of the object OBJ can be acquired.

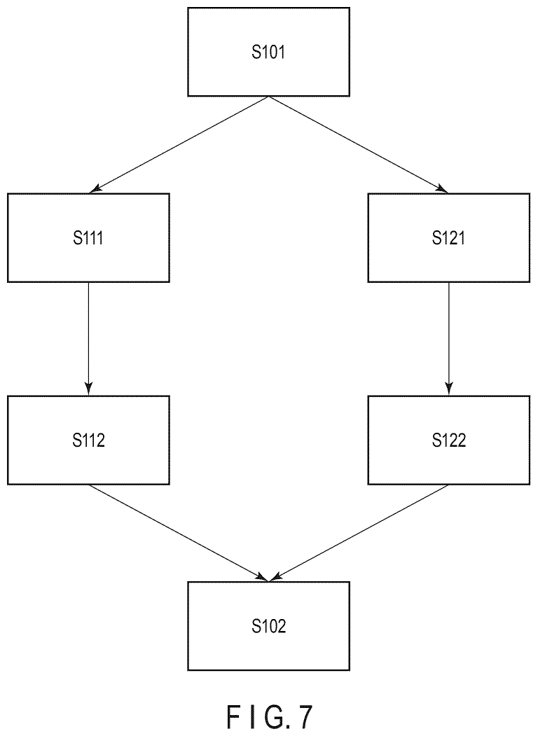

FIG. 7 is a diagram showing the operations of the optical device. In the optical device OPD, the following operations are performed based on control signals from the controller CTL. First, an image of the object OBJ is captured in the state where the coded aperture pattern displayed on the liquid crystal panel PNL is included. This capture is performed using both infrared light and visible light (Step S101).

The amount of visible light does not change even after passing through the liquid crystal panel PNL. At the sensor elements of the imaging device IS, light of red (R), green (G), and blue (B) is detected. The detected light is converted into current by photoelectric conversion. This current value is amplified by a predetermined amplification rate and transmitted to the controller CTL as the information of red (R), green (G), and blue (B) (Step S111). It suffices only if the amplification rate for the current values is such as to achieve white balance for red (R), green (G), and blue (B).

Infrared light is modulated by the liquid crystal panel PNL. Consequently, the amount of the infrared light decreases as it passes through the liquid crystal panel PNL. This infrared light whose amount has been reduced is detected by the sensor elements of the imaging device IS. Then, the infrared light is subjected to photoelectric conversion into current, and thereafter this converted current is amplified at an amplification rate different from that of the visible light. The amplified current is transmitted to the controller CTL as encoded aperture data (step S121).

Here, only infrared light is modulated by the liquid crystal panel PNL. Therefore, encoded aperture data is applied only to the infrared light, and no encoded aperture data is applied to the visible light. Note that the visible light contains color information (red (R), green (G), and blue (B)) of the object OBJ.

The controller CTL generates a two-dimensional color image containing color information based on the current converted from the visible light (step S112). The controller CTL calculates out the distance between the optical device OPD and the object OBJ based on the current converted from the infrared light and thus obtains the distance information thereof (step S122).

The controller CTL synthesizes the above-described color two-dimensional image and the above-described distance information. In this manner, a two-dimensional image containing both color information and distance information can be generated (step S102).

The liquid crystal panel PNL of the optical device OPD in the embodiment has polarizers that polarize infrared light and transmit visible light. The depth information (position) is measured based solely on the information from infrared light. The visible light is used to detect the color information of the object OBJ. Therefore, the luminance of the visible light does not change, and therefore there is no need to adjust the white balance for red (R), green (G), and blue (B).

To measure distance using color information, it is conventionally necessary to convert the color information to grayscale as described above. But in the optical device OPD of the embodiment, distance is measured using infrared light without utilizing color information. With this configuration, there is no need to convert color information to grayscale, thereby making it possible to reduce the processing time.

Further, when CMOS sensors are used as the sensor elements of the imaging element IS, such an advantage can be obtained. To explain, the CMOS sensors are often formed by using silicon (Si). Silicon (Si) has a high photoelectric conversion efficiency for infrared light. Therefore, an imaging element IS with CMOS sensors has the advantage that the S/N ratio may be higher in the case of using infrared light compared to the case of using visible light.

### Configuration of Liquid Crystal Panel

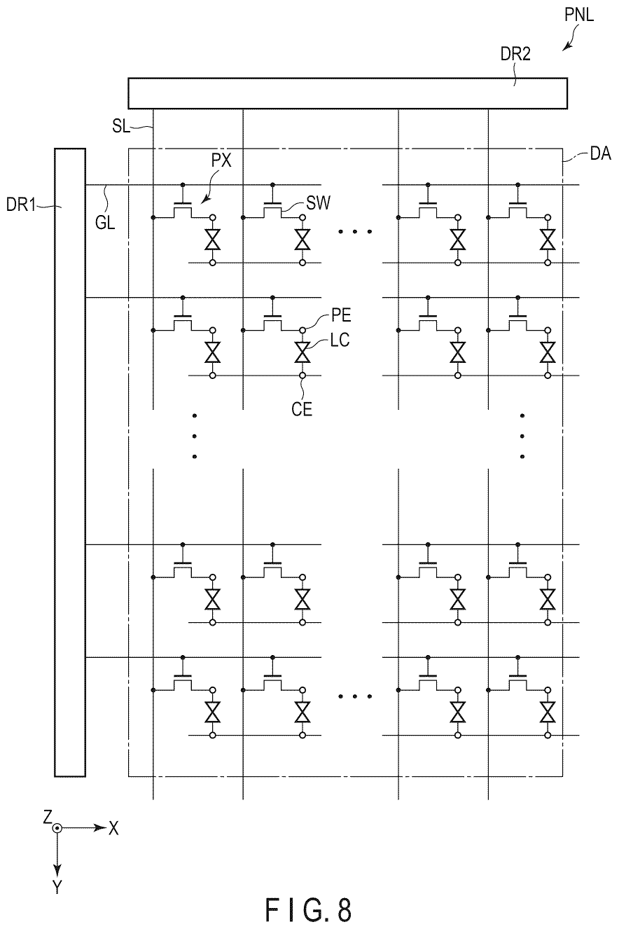

FIG. 8 is a diagram showing an example of an equivalent circuit of the liquid crystal panel. The liquid crystal panel PNL includes, within the display area DA that displays a coded aperture pattern, a plurality of pixels PX, a plurality of scanning lines GL, and a plurality of signal lines SL. These scanning lines GL and signal lines SL intersect each other.

The liquid crystal panel PNL comprises a driver DR1 and a driver DR2 on an outer side of the display area DA. The scanning lines GL are electrically connected to the driver DR1. The signal lines SL are electrically connected to the driver DR2. The driver DR1 and the driver DR2 are controlled by the controller.

Each of the pixels PX is disposed at the intersection of each of the scanning lines GL and each respective one of the signal lines SL. Further, each of the pixels PX is partitioned by each adjacent pair of scanning lines GL and each respective adjacent pair of signal lines SL.

Each of the pixels PX comprises a switching element SW, a pixel electrode PE, and a common electrode CE which faces the pixel electrode PE. The switching element SW is electrically connected to the respective one of the scanning lines GL and the respective one of the signal lines SL. The pixel electrode PE is electrically connected to the switching element SW. That is, the pixel electrode PE is electrically connected to the signal line SL via the switching element SW. The common electrode CE is formed over multiple pixels PX. To the common electrode CE, a common potential is applied.

The driver DR1 supplies scanning signals to scanning lines GL. The driver DR2 supplies image signals to signal lines SL. At the switching element SW electrically connected to the scanning line GL, to which a scanning signal is supplied, the signal line SL and the pixel electrode PE are electrically connected to each other. With this configuration, a voltage according to the image signal supplied to the signal line SL is applied to the pixel electrode PE. The liquid crystal layer LC is driven by the electric field generated between the pixel electrode PE and the common electrode CE. More specifically, the electric field generated between the pixel electrode PE and the common electrode CE changes the alignment of the liquid crystal molecules in the liquid crystal layer LC from their initial alignment state where no voltage is being applied. By this operation, the coded aperture pattern is displayed in the display area DA.

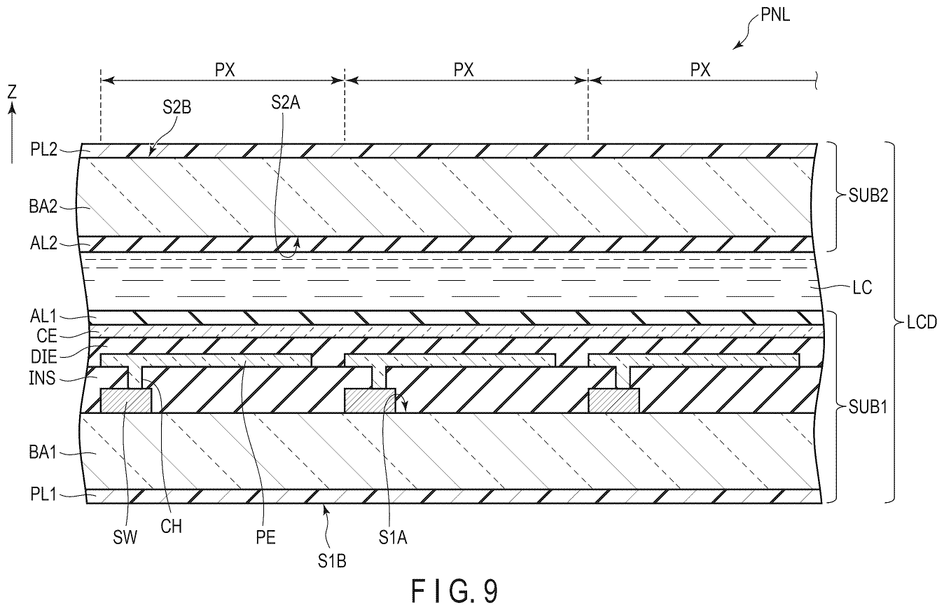

FIG. 9 is a cross-sectional view showing an example of the configuration of the liquid crystal panel. The liquid crystal panel PNL comprises a substrate SUB1, a substrate SUB2, a liquid crystal layer LC, a polarizer PL1, and a polarizer PL2. The liquid crystal layer LC is held between the substrate SUB1 and the substrate SUB2. The polarizer PL1 is provided in contact with the substrate SUB1. The polarizer PL2 is provided in contact with the substrate SUB2. The substrate SUB1, the liquid crystal layer LC, and the substrate SUB2 constitute the liquid crystal device LCD.

The substrate SUB1 further comprises a base BA1, an insulating layers INS, an insulating layer DIE, and an alignment layer AL1 in addition to the switching elements SW, the pixel electrodes PE, the common electrode CE, and the like. Further, the substrate SUB1 includes the scanning lines GL, the signal lines SL, the driver DR1, the driver DR2, and the like, shown in FIG. 1.

The base BA1 is formed from a light-transmissive glass substrate, resin substrate, or the like. The base BA1 has a main surface S1A facing the substrate SUB2 and a main surface S1B on an opposite side to the main surface S1A.

The switching elements SW are formed on a main surface S1A side of the base BA1 and is covered by the insulating layer INS. Note that in the example shown in FIG. 9, for the sake of simplicity in describing the embodiment, the switching elements SW are shown in a simplified form, and the illustration of the scanning lines GL and signal lines SL is omitted. In practice, the insulating layers INS may include multiple insulating layers. The switching elements SW each includes semiconductor layers and various electrodes formed in these layers.

The pixel electrodes PE are formed on the insulating layer INS and are arranged for each group of multiple pixels PX. The pixel electrodes PE are covered by the insulating layer DIE. A common electrode CE is provided over multiple pixels PX. The common electrode CE is formed on the insulating layer DIE and provided to face the pixel electrodes PE via the insulating layer DIE.

The pixel electrodes PE are each electrically connected to the respective switching element SW through a contact hole CH penetrating the insulating layer INS. The pixel electrodes PE and common electrode CE are transparent electrodes formed from a transparent conductive material such as indium tin oxide (ITO), indium zinc oxide (IZO) or the like.

The alignment layer AL1 covers the common electrode and is in contact with the liquid crystal layer LC. The alignment layer AL1 is a photo-alignment film subjected, for example, to photo-alignment treatment.

The substrate SUB2 comprises a base BA2 and an alignment layer AL2. The base BA2 is formed from a light-transmissive glass substrate, resin substrate, or the like. The base BA2 has a main surface S2A facing the substrate SUB1 and a main surface S2B on an opposite side to the main surface S2A.

The alignment layer AL2 is provided in contact with the base BA2 and is in contact with the liquid crystal layer LC. The alignment layer AL2 is a photo-alignment film that has been subjected to photo-alignment treatment, as well as in the case of the alignment layer AL2.

Between the alignment layer AL2 and the base BA2, an insulating layer or a light-shielding layer facing the switching element SW may as well be provided.

Onto the main surface S1B of the base BA1, a polarizer PL1 is adhered, and a polarizer PL2 is bonded to the main surface S2B of the base BA2. In other words, the first base BA1 is disposed between the liquid crystal layer LC and the polarizer PL1. The second base BA2 is disposed between the liquid crystal layer LC and the polarizer PL2. Further, in other words, the first substrate SUB1 is disposed between the liquid crystal layer LC and the polarizer PL1. The second substrate SUB2 is provided between the liquid crystal layer LC and the polarizer PL2. As described above, the polarizer PL1 and the polarizer PL2 polarize infrared light and transmit visible light.

The optical device of the embodiment can suppress a reduction in the amount of light reaching the imaging surface of the imaging element. The optical device of this embodiment can shorten the computation time of the controller.

In this disclosure, the current obtained by photoelectric conversion of visible light is referred to as a first current. The amplification rate of this first current is referred to as a first amplification rate. The current obtained by photoelectric conversion of infrared light is referred to as a second current. The amplification rate of this second current is referred to as a second amplification rate. The second amplification rate differs from the first amplification rate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. An optical device comprising:
a liquid crystal panel which displays a coded aperture pattern;
an optical system including a lens;
an imaging device including a plurality of sensor elements and a plurality of color filters; and
a controller connected to the liquid crystal panel, the optical system, and the imaging device,
wherein
the liquid crystal panel comprises a polarizer which modulates infrared light and transmits visible light.

2. The optical device according to claim 1, wherein
the plurality of sensor elements include a first sensor element which detect visible light and a second sensor elements which detect infrared light.

3. The optical device according to claim 1, wherein
an object is imaged using the infrared light and the visible light while displaying the coded aperture pattern on the liquid crystal panel,
the visible light passing through the liquid crystal panel is converted into a first current by photoelectric conversion, the first current is amplified at a first amplification rate, and the first current amplified by the first amplification rate is transmitted to the controller as color information;
the infrared light passing through the liquid crystal panel is converted into a second current by photoelectric conversion, the second current is amplified at a second amplification rate different from the first amplification rate, and the second current amplified by the second amplification rate is transmitted to the controller as encoded aperture data,
the controller generates a two-dimensional color image based on the first current amplified at the first amplification rate,
the controller calculates out distance information between the object and the optical device based on the second current amplified at the second amplification rate, and
the controller synthesizes the two-dimensional color image and the distance information together, and generates a two-dimensional image containing both the color information and the distance information.

4. The optical device according to claim 1, wherein
the coded aperture pattern has a non-point-symmetric shape.

5. The optical device according to claim 1, wherein
the liquid crystal panel includes:
a first substrate;
a second substrate; and
a liquid crystal layer disposed between the first substrate and the second substrate,
wherein
the polarizer comprises a first polarizer and a second polarizer,
the first substrate is disposed between the liquid crystal layer and the first polarizer, and
the second substrate is disposed between the liquid crystal layer and the second polarizer.
